(19) United States
(12) Patent Application Publication
(10) Pub. No.: US 2003/0131354 A1
(43) Pub. Date: Jul. 10, 2003

(54) Method of providing programming reminders for future television programming events

(76) Inventor: Joseph R. Lanser, Algonquin, IL (US)

Correspondence Address: Joseph R Lanser, 1370 Yosemite Parkway, Algonquin, IL, 60102, US

(21) Appl. No.: 09/683,478

(22) Filed: Jan. 4, 2002

(51) Int. Cl. H04N 5/445

(52) U.S. Cl. 725/37; 725/58

(57) ABSTRACT

A method of providing programming reminders and recording settings for future television programming events. The present invention incorporates a unique, identifying code within a future television programming event preview. Upon viewing the preview, the viewer selects the preview and the present invention automatically gathers and conveys the identifying information contained within the identifying code to the television system. The viewer can then choose how a reminder should be provided to remind the viewer when the desired future programming event is being broadcast.

### BACKGROUND OF INVENTION

The present invention relates generally to an automated method of providing television programming reminders and recording settings to a user or television system. More specifically, the present invention relates to a method of providing television programming previews, depicting future television programming broadcasts, with an underlying code wherein a television viewing user, upon seeing the programming preview, can simply click a selectable button on a remote control or other device and the future programming information, such as date, channel and time, will be entered into the television system's memory to either record the selected program or remind the viewing user at the designated future time.

As discussed within this specification, television system refers to any system which contains a broadcast receiving means for receiving and decoding television programming broadcasts, in either analog or digital format, and a displaying means for displaying the decoded information. For example, a conventional television system which contains an internal or external receiver, and a cathode ray tube (CRT) would be included within this description. Furthermore, new and improved techniques, such as conventional computer systems configured to receive, display and/or record analog and/or digital broadcasts, Internet television transmissions and the like, would also be included. As such, the definition of television system should be construed broadly wherein the examples contained herein are simple exemplifications and should not be deemed limiting.

Television programming revenue is currently based upon attracting as many viewers as possible. As such, television programming providers generally provide future programming information and previews to entice current television viewers to return to the same channel at a future time and/or date. These television programming previews generally take the form of time compressed summaries of the upcoming program, highlights, features, synopsis, and the like. To accomplish this task, future television programming previews generally provide, either aurally, visually, or both, future programming information such as title of program, channel, date and time that the future program will be broadcast. Television programming providers thus rely on the future television programming preview to visually stimulate and subsequently remind television viewers of the future program. Generally, this is accomplished wherein the television viewer mentally reminds himself of the desired program at the future date and/or time. However, as can be expected, viewers typically forget about the future programming event and thus inadvertently miss its broadcast.

As such, there is a current need within the television programming industry for a method of automating the process of collecting future program information and providing subsequent reminders of the future television programming based upon present television programming previews. It is currently a common practice to be watching television and see an upcoming show or program preview that a viewer desires to remind himself to watch. For example, if you are watching television on a Wednesday at 8:00 pm and a television programming preview is displayed announcing an interesting upcoming show on Friday at 9:00 pm, you have to mentally remind yourself on Friday that the program is playing. Otherwise, you will forget.

Other current methods of reminding of future programming is to manually enter the desired programming information into a semi-automated method of reminding contained within the television system. Such methods include the reminders available via conventional television displayed programming menus, such as found within satellite television systems, cable television systems, digital television systems, and the like. Currently, under these systems, a user, upon viewing a programming preview of a future television program, has to manually enter pertinent reminder information into the television system. Conventionally this is accomplished by accessing the television system's programming menu, searching for the date, time and channel of the desired program and setting a reminder. However, limitations of such methods of reminding include the user sometimes forgets to set the programming reminder, it is quite cumbersome and complicated to search and find the desired future programming, and often the television programming menus do not forecast far enough into the future to be of valuable use by actually providing the desired future programming information. The present invention overcomes such limitations by, for example, providing a method of instantaneously and automatically entering reminder information into the television system.

Yet, other methods of reminders include electronic mail services provided by the programming provider wherein the programming provider will send an email to the viewer reminding him of the programming event. However, limitations of such a system include the viewer must have access to the electronic mail at the time of the programming event, and even upon reading the reminder email, the viewer will often forget about the programming event when it occurs, and the viewer must manually notify the programming provider to send the email regarding the future programming at a later date. The present invention overcomes such limitations by, for example, providing a method of instantaneously and automatically programming a reminder feature within the television system upon viewing the preview broadcast, not requiring email access at the time of television viewing, and reminding the viewer of the desired programming event when the programming event occurs.

### SUMMARY OF INVENTION

The present invention is best described as a method of providing and storing future television programming reminders. The present invention utilizes an information code, preferably embedded within a television programming preview depicting a future television programming event, which provides the television system information necessary to create a future reminder event. Such information contained within the information code may include, for example, channel (broadcast frequency), title, date and time of the desired future program. As such, when a viewer is currently viewing a preview of a future program which he desires to watch, the viewer can simply push a single button, such as on a remote control, notifying the television system to set a reminder event for the future programming whereupon the television system obtains the identifying information for the future programming event from the information code.

Preferably, the information code is carried on the same frequency as the television programming preview broadcast and the code can be in either a digital or analog format. It is preferably in a digital format due to the increased amount of information which can potentially be carried within the information code. Alternately, it can be carried independently on a different frequency.

The reminder event can take on numerous different forms. Such forms may consist of providing an email to the viewer, paging the viewer, automatically calling the viewer, providing an on-screen programming reminder while the viewer is watching the television system, automatically changing to the desired channel, automatically recording the programming event with a recording means, and the like. The forms of reminder events are quite limitless.

Furthermore, the present invention has the ability to provide the television viewer with a log of all programmed reminder events. As such, by accessing this log, the viewer can modify, manually add or delete programming reminder information.

Also, the present invention automatically provides a conflict of time notice if there is already a conflicting future programming event programmed within the television system.

It is an object of the present invention to provide an improved method of providing a reminder event for future television programs.

It is yet another object of the present invention to provide an automated process of setting a reminder event for a future television program.

It is still another object of the present invention to provide a process of automatically obtaining information, such as time, date, and channel, about a future programming event utilizing an information code embedded or “piggy-backed” with the future programming event preview.

Another object of the present invention is to provide programming information, such as time, date and channel, along with a future television programming event preview.

### DETAILED DESCRIPTION

The preferred embodiment of the present invention is best described as a method of providing and storing future television programming reminders. The preferred embodiment utilizes an identifying information code (“information code”) simultaneously broadcasted with a television programming preview (“preview”), wherein the preview depicts a future television programming event. The information code preferably contains conventional identifying information such as the channel, time and date of the future television programming event. Alternately, the information code can contain any additional or other related information, such as, for example, future television programming event summary, synopsis, actors, directors, related television programs, biographies and the like. Still alternately, the information code can consist of new and improved methods of identifying television programming, such as, for example, Internet Protocol addressing (IP), Domain Name Service (DNS), Uniform Resource Locator (URL), or Uniform Resource Identifier (URI) (as is proposed in RFC2838 and RFC2396 available at http://www.ip.com). Still alternately, the information code can adhere to any specification as proposed and/or adopted by the ATVEF Enhanced Content Specification. In any embodiment, however, the information code is preferably unique wherein it will be specific enough to distinguish numerous future programming events.

The preferred embodiment of the present invention broadcasts the identifying information code in digital format. Alternately, the information code can be broadcast in analog or other formats. Also preferably, the information code is embedded within the preview and is thus broadcasted simultaneously and on the same broadcast frequency as the preview. Alternately, the information code can be simultaneously “piggy-backed” along with the preview, or it can be simultaneously broadcasted on a different or independent frequency. Such independent frequency may, for example, be dedicated for exclusively broadcasting the present invention's information codes.

A television system, defined broadly as any device which can receive television broadcasts with a receiving means and use a displaying means to display the broadcast or use a recording means to record the broadcast, is used in conjunction with the present invention. For example, a television system as herein defined, may include, but is not limited to, a conventional television with an internal receiver and a cathode ray tube (CRT), a computer which is configured to receive television broadcast signals, television broadcast over the Internet, digital satellite television systems, cable television systems, digital recording means such as digital video recorders, analog recording means such as video cassette recorders, and the like. As such, the definition of television system should be construed broadly wherein the examples contained herein are simple exemplifications and should not be deemed limiting. Furthermore, the term “user” and “viewer” are used herein interchangeably and mean the same thing which is the person who is viewing or using the television system.

The preferred embodiment of the present invention further incorporates a code reading means to read the broadcasted information code, as well as a storing means to store the information obtained from the information code, within the television system. As such, when a user is watching television and views a preview which he desires to receive a reminder about, the user simply selects that preview with a selecting means, while the preview is being displayed on the television system, or shortly thereafter, and the present invention relays the identifying information within the information code to the television system, wherein the television system will provide a reminding means. The preferred selecting means is a remote control button wherein when the user is viewing a desired preview which he would like a reminder for, he simply selects the preview with the remote control button wherein the remote control button will send an independent signal to the television system denoting the user's desire to obtain the information code for that specific preview. Alternately, the selecting means can be voice activation, touch screen technologies, multiple remote control buttons, and the like.

Upon selecting the desired preview with the selecting means, the information code is obtained by the code reading means. The code reading means then sends the information obtained from the information code to a storing means, wherein the future program identification information will be stored. Subsequent to selecting the preview with the selecting means, the present invention preferably presents the user with a plurality of options of different reminding means which provide a reminder event. The preferred reminding means is an automatic visual reminder which is displayed on the television system on the date and time of the future television programming event. For example, if a user selects a preview for a television program which will be broadcasted on Friday at 8:00 pm, the preferred embodiment of the present invention will display a visual reminder on the television system display means on Friday at 8:00 pm notifying the user that his pre-selected and desired show is now being broadcast. Furthermore, the preferred embodiment of the present invention will, upon displaying the preferred reminding means, provide an option to automatically tune to the channel of the desired television program. Also, a default reminding means can be predetermined.

Alternately, the reminding means can be a paging system wherein the television system can page the user on the date and time of the future television program, an electronic mail system, automatically changing to the channel, telephoning the viewer, or a recording means. The recording means can be either analog or digital wherein it is intended that if the user selects the recording means option, the television system will convey the future program's identifying information within the information code to the recording means whereby the recording means will automatically record the future television programming event on the event's date, time and channel. Still alternately, and within any of the embodiments of the present invention, the reminding means can be configured to provide a reminding means a designated amount of time prior to the actual time of the future television programming event. For example, if the actual broadcast time of the television programming event is Friday at 8:00 pm, the reminding means can provide its reminder event at 7:55 pm on Friday.

The present invention preferably has the ability to provide the television viewer with a log of all programmed reminder events. As such, by accessing this log, the viewer can modify, manually add or delete programming reminder information.

Also, the preferred embodiment of the present invention automatically provides a conflict of time notice if there is a conflicting future programming event programmed within the television system.

While preferred and alternate embodiments have been described herein, it is to be understood that these descriptions are only illustrative and are thus exemplifications of the present invention and shall not be construed as limiting. It is to be expected that others will contemplate differences, which, while different from the foregoing description, do not depart from the true spirit and scope of the present invention herein described and claimed.

1. A method of providing program information for a future television program to a television system through a future programming preview, said method comprising the steps of:
creating an identifying code, said identifying code being unique to identify said future television program; and
broadcasting said identifying code simultaneously with said future programming preview.

2. A method as claimed in claim 1 wherein said identifying code contains timing information relating to said future television program.

3. A method as claimed in claim 1 wherein said identifying code contains broadcast channel information relating to said future television program.

4. A method as claimed in claim 1 wherein said identifying code contains program summary information for said future television program.

5. A method as claimed in claim 1 wherein said identifying code is a unique Uniform Resource Locator identifier.

6. A method as claimed in claim 1 wherein said identifying code is a unique Uniform Resource Identifier.

7. A method as claimed in claim 1 wherein the step of broadcasting said identifying code simultaneously with said future programming preview further includes the step of encoding said identifying code.

8. A method as claimed in claim 1 wherein the step of broadcasting said identifying code simultaneously with said future programming preview further includes the step of embedding said identifying code within said future programming preview.

9. A method of selecting a future television program broadcast event and relaying the future television broadcast information to a television system through the use of an identifying code broadcasted with a future television event programming preview, said method comprising the steps of:
selecting said future television event programming preview with a selecting means while said future television event programming preview is being viewed by a user;
reading said identifying code broadcasted with said future television event programming preview;
storing said identifying code within said television system; and
selecting a future reminder function.

10. A method as claimed in claim 9 wherein said selecting means is a button on a remote control, said remote control having the ability to send a signal to said television system.

11. A method as claimed in claim 9 wherein said selecting means is a means of using speech recognition to audibly select said future television event programming preview with human speech.

12. A method as claimed in claim 9 wherein said selecting means is an input means for a computer system.

13. A method as claimed in claim 9 wherein said future reminder function is a recording means.

14. A method as claimed in claim 13 wherein said recording means is an analog recording system.

15. A method as claimed in claim 13 wherein said recording means is a digital recording system.

16. A method as claimed in claim 9 wherein said future reminder function is a reminding means.

17. A method as claimed in claim 16 wherein said reminding means is an electronic mail message.

18. A method as claimed in claim 16 wherein said reminding means is a message displayed on said television system.

19. A method as claimed in claim 16 wherein said reminding means is a message sent to a paging system.

20. A method as claimed in claim 16 wherein said reminding means is a means to automatically switch said television system to said future television program broadcast event.

21. A method as claimed in claim 9 wherein the step of selecting a future reminder function can be a predetermined default.
